(19) United States
(12) Patent Application Publication
(10) Pub. No.: US 2017/0225867 A1
(43) Pub. Date: Aug. 10, 2017

(54) FOOD PRESERVATION WITH SILVER-BIOMASS

(71) Applicant: UNIVERSITY OF CALCUTTA, Kolkata (IN)

(72) Inventors: Anjan Kr. DASGUPTA, Kolkata (IN); Ruma PAL, Kolkata (IN); Piya Roy CHOUDHURY, Karimpur (IN)

(73) Assignee: UNIVERSITY OF CALCUTTA, Kolkata, West Bengal (IN)

(21) Appl. No.: 15/424,847

(22) Filed: Feb. 4, 2017

(30) Foreign Application Priority Data
Feb. 6, 2016 (IN) 201631004319

(51) Int. Cl. B65D 81/26; B65B 25/00; B65D 25/04; A23L 3/00; B65D 43/02

(52) U.S. Cl. CPC B65D 81/268; A23L 3/00; B65D 43/0204; B65D 25/04; B65D 43/0214; B65D 43/0225; B65B 25/001; A23V 2002/00

(57) ABSTRACT

A food preservation system can include a gas (e.g., oxygen) permeable package having at least one oxygen permeable member defining a package chamber therein, and a silverized biomass in the package chamber of the oxygen permeable package. Another food preservation system can include a container having an internal chamber, and an oxygen permeable divider located in the internal chamber so as to divide the internal chamber into a first chamber and a second chamber. The first chamber can being configured for receiving food therein, and a silverized biomass is located in the second chamber. A method of preserving food can include retaining a food in a container that includes silverized biomass such that the food does not contact the silverized biomass. The silverized biomass can have a combination of silver and biomass.

### FIELD OF TECHNOLOGY

The field of the technology relates to the use of silver and a biomass (e.g., silverized biomass), which includes biomass treated with silver, in food preservation systems and methods.

### BACKGROUND

Even though food preservation techniques have been researched and utilized throughout the duration of humankind, food continues to become spoiled and inedible. Common causes of food becoming spoiled and/or inedible are related to oxidation of the food and microbial (e.g., bacterial and fungal) growth on the food. Food spoilage may occur at any time during post-harvest handling (e.g., from harvest to consumption), post-cooking (e.g., from cooking to consumption), or post-preparation (e.g., from preparation to consumption). The food may become inedible due to significant oxidation that may produce staleness, bad odors, color change, and overall appearance of inedibility. Additionally, food may be contaminated with microbes that infect the food to cause spoilage and rotting of the food. Thus, improvements in food preservation and shelf-life continue to be needed in developing and developed countries regardless of geographical location

### OBJECT

An object of the technology described herein is to improve food preservation and shelf-life with systems and methods that utilize silverized biomass to inhibit oxidation and microbial contamination. The foregoing object is illustrative only and is not intended to be in any way limiting.

### STATEMENT

The technology includes food preservation systems and methods that use silverized biomass (e.g., biomass treated with silver). The food preservation systems can include oxygen permeable packages having the silverized biomass therein, and containers that maintain food separately and without contact with the silverized biomass by an oxygen permeable barrier between the silverized biomass and food. The methods can utilize the food preservation systems for enhancing food preservation. The foregoing statement is illustrative only and is not intended to be in any way limiting.

### SUMMARY

In one embodiment, a food preservation system can include a porous package (e.g., an oxygen permeable package) having at least one gas (e.g., oxygen) permeable member defining a package chamber therein. A silverized biomass can be included in the package chamber of the porous package. The silverized biomass can have a combination of silver and biomass. The silver and biomass may interact so as to cause reduction of the silver and consumption of oxygen so that the oxygen cannot oxidize the food and/or so that microbes (e.g., aerobic microbes) are deprived of oxygen.

In one embodiment, a food preservation system can include a container having an internal chamber. A gas (e.g., oxygen) permeable divider can be located in the internal chamber so as to divide the internal chamber into a first chamber and a second chamber. The first chamber can be configured for receiving food therein, and the second chamber can be configured for receiving or retaining a silverized biomass. The silverized biomass can have a combination of silver and biomass as described herein.

In one embodiment, a method of preserving food can include retaining a food in a container that includes silverized biomass such that the food does not contact the silverized biomass. The silverized biomass can have a combination of silver and biomass as described herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an embodiment of a food preservation system;

FIG. 2 illustrates another embodiment of a food preservation system;

FIG. 3 illustrates an embodiment of food preservation package;

FIG. 4 illustrates another embodiment of a food preservation package; and

FIG. 5 illustrates an embodiment of a food preservation system employing the food preservation package of FIG. 4,

arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the technology described herein relates to systems and methods for food (e.g., fruit and vegetable) preservation. The systems and methods may inhibit the availability of oxygen to food, which includes removing oxygen from oxygen-dependent biological functions in order for the food to have an extended shelf life. The systems and methods may be utilized at the time of harvesting the fruit and vegetable foods, and may be utilized during post-harvest packaging. The systems and methods may be utilized to enhance preservation of other cultivated foods, such as but not limited to seeds and nuts, as well as the fruits and vegetables that are plant based and grown from the ground. As such, reference herein to a “cultivated food” is meant to describe a fruit, vegetable, nut, or seed, or any other edible plant-based food that is grown and cultivated. The systems and methods described herein can also be used for preservation of processed foods or any cooked foods in order to increase shelf life. Accordingly, the systems and methods may also be used for enhancing the preservation of any food by the mechanisms described herein, without limitation. Any food that may need preservation can be preserved with the systems and methods that inhibit oxidation of the foods and/or inhibit microbial infection of the foods by removing oxygen.

The systems and methods described herein can be beneficially used for preservation of post-harvest cultivated food in order to increase shelf life and allow for consumption of cultivated food long after harvesting. However, the systems and methods may also be used for processed foods to enhance preservation thereof. The systems and methods may be employed in any geographic area, and may be applied at any time after cultivation or production of the food. However, it may be beneficial to implement the systems and methods soon after harvesting or production, which may include such systems being utilized in agricultural areas, such as farms, or in general food processing, preparation or cooking plants or operations. The systems and methods may be beneficial in areas that lack standard industrialization and processing of foods, such as in developing countries, and may also be utilized in industrialized regions and implemented in the processing of foods on large scales.

The systems and methods may also be utilized in stores to preserve the foods, and may be included in packaging having the foods. As such, the packaging that utilizes the systems and methods may retain the food to have good quality after purchase and prior to consumption, and during any transportation or storage of the food. The systems and methods may also be used in homes for increased food preservation and shelf life. The system and methods may also be used for increasing food preservation in food supplies or food storage systems, such as emergency food storage that is intended to have very long shelf lives (e.g., 5 years, 10 years, 30 years, etc.). The systems and methods may also be adapted to be used for food transportation in instances without traditional refrigeration. An example of a use can include hiking or backpacking, where the systems and methods can preserve the food during such activities for longer preservation without refrigeration. On the other hand, the systems and methods may be practiced in food packaging in refrigerators or freezers. The food packaging utilizing the systems and methods may be pressurized or at normal (e.g., ambient) pressures or in a vacuum. Accordingly, the systems and methods may be practiced at a range of temperatures and pressures. Thus, the systems and methods can be utilized anywhere for enhanced preservation and shelf life extension of foods.

The systems and methods can be utilized for increasing preservation and shelf life of cultivated food (e.g., food grown and cultivated from the earth that is harvested) or prepared food (e.g., food that is prepared in some matter, such as cutting, slicing or dicing with or without cooking) or cooked food (E.g., food that is cooked). The food may be plant-based or animal-based or combination thereof.

The systems for preserving foods include the use of silver-transformed biomass, which can be referred to herein as silverized biomass. The silverized biomass is a biomass that has been transformed with silver ions, and where there is chemical reduction of the silver by the biomass, which results in the biomass utilizing oxygen to balance the reduction-oxidation reactions. That is, the silver ions are reduced by the biomass, and the reduced biomass is oxidized by the oxygen, which results in a net loss of oxygen in and around the silverized biomass. In an open atmosphere, the localized region around the silverized biomass can have reduced oxygen; however, oxygen can diffuse into the reduced oxygen region around the silverized biomass. While the use of silverized biomass for oxygen reduction can work in an open environment (e.g., open to the air or to ambient conditions), the silverized biomass may advantageously be included in an airtight (e.g., oxygen-tight) or otherwise closed container that does not allow for oxygen to freely enter into the container when oxygen content is reduced in the container.

In one embodiment, the silver ions that are introduced to the biomass are reduced to form silver nanoparticles (e.g., AgNP) by the biomass, and the reducing activity kills the biomass (e.g., algal biomass), which thereby activates the biomass to consume more oxygen to retain the redox balance. As a result, there is less oxygen available to damage the food by oxidation. As another result, there is less oxygen for aerobic microbes, and thereby there is less ability of aerobic microbes to contaminate the food. In yet another result, the silver ions from the silver have an antimicrobial activity when microbes contact the silver ions.

The silverized biomass can be any biomass that is silverized as described herein. In one example, the silverized biomass can form silver particles, such as microparticles or nanoparticles, or particles of any size. The small particles of silver formed by the silverized biomass can be beneficial because of the increase in surface area of silverized biomass that can increase the amount of oxygen absorbed or otherwise withdrawn from the environment around the silverized biomass. However, large silverized biomasses (e.g., greater than 100 microns or greater than 1 mm in diameter) may also be used.

The silverized biomass can be exemplified without limitation by silverized algae. However, the biomass can be substantially any biomass that can be silverized to provide a redox environment that diminishes the available oxygen. The biomass can be any algae whether unicellular or multicellular, such as: Chlorella, Charophyta, or other green algae (e.g., Rhizoclonium fontinale, Ulva intestinalis, Chara zeylanica and Pithophora oedogoniana); diatoms whether single diatoms or ribbons (e.g. Fragilaria), fans (e.g. Meridion), zigzags (e.g. Tabellaria), or stars (e.g. Asterionella); kelp algae, Macrocystis or other brown algae, red algae, seaweed algae, blue-green algae (e.g., cyanobacteria, such as Leptolyngbya valderiana, P. tenue and Microcoleus chthonoplastes), or others. For the purposes of this disclosure, cyanobacteria are considered to be algae. The biomass may also be other aquatic organisms similar to algae, or aquatic plants that can perform the same food preservation function as described herein. The biomass may be terrestrial or land-based plants that can perform the same food preservation function as described herein.

The silverized biomass can be prepared by introducing silver to the biomass in order to facilitate the redox reaction that diminishes the oxygen. The silver can be provided we in an aqueous composition or dry, such as in a powder. The silver can be any silver salt such as nitrate, fluoride, acetate, permanganate, sulfate, nitrite, bromate, salicylate, iodate, dichromate, chromate, carbonate, citrate, phosphate, chloride, stearate, oxide, sulfide, bromide, iodide, cyanide, arsenate, azide, benzoate, oxalate, sulfite, or thiocyanate. In one aspect, the silver salt can be highly water soluble, such as silver nitrate (AgNO₃); silver fluoride (AgF); silver acetate (AgC₂H₃O₂); silver permanganate (AgMnO₄); silver sulfate (AgSO₄); silver nitrite (AgNO₂); or silver bromate (AgBrO₃).

The silverized biomass can be used for preservation of foods by reducing oxygen. The reduction of oxygen can reduce oxidative damage to the foods, and can reduce oxygen to oxygen-requiring microbes that may infect the food. As such, silverized biomass can implement a two-pronged approach to food preservation by oxygen reduction.

The silverized biomass can be included in the systems and methods to lower the rate of microbial infections of the foods by reducing and/or inhibiting the availability of oxygen to such microbes. The silverized biomass may also have antimicrobial properties from the silver component that can inhibit microbes that contact the silverized biomass. This allows the silverized biomass to be applied to surfaces or objects that may have microbes to impart the antimicrobial effect to the surface or object, and to simultaneously also reduce the oxygen content that inhibits the growth and/or propagation of the microbes. This allows the silverized biomass to be effective in inhibiting microbes by contacting the microbes to provide the antimicrobial action or by being present in an environment with the microbes without directly contacting the microbes. Now, silverized biomass can be included in a closed system with microbes, without direct contact with the microbes, in order to impart the antimicrobial activity by utilizing oxygen in the closed system so that the oxygen is not available to the microbes. Such non-contact antimicrobial action may be performed in open air, but may be more effective in a closed container that is airtight or has restricted air exchange. The systems and methods can be implemented to inhibit a microbial infection, such as a bacterial infection or fungal infection of the food; however, viral infections or other microbial infections of food may also be inhibited. The systems and methods may be utilized at any time after harvesting of the cultivated food or preparation of a prepared food or cooking of a cooked food in order to inhibit microbial infection and physical manifestation of the microbial infection in the food.

The systems and methods described herein may also be implemented with other processes for inhibiting microbial infections of foods. Such other processes can include anything that inhibits microbes, such as substances that inhibit the microbes, temperatures that inhibit the microbes, pressures that inhibit the microbes, gasses that inhibit the microbes, or anything else. For example, an antibiotic or antifungal can be applied to the food, and the food can be placed in a container with the silverized biomass in order to have a multi-action antimicrobial effect. The container may also be filled with ethylene gas (e.g., atmospheric or pressurized) for antimicrobial effect. The container may also be chilled (e.g., 4° C. or lower) for antimicrobial effect.

In one example, the systems and methods may be utilized to inhibit mycotoxin contamination, and thereby may inhibit spoilage of foods. The systems and methods may inhibit the fungi of mycotoxin-producing fungal genera. That is, the fungi may be inhibited so that the mycotoxin contamination is inhibit, which can be beneficial in food preservation. Some non-limiting examples of the fungal genera that can be inhibited in order to inhibit mycotoxin production can include Aspergillus, Fusarium, and Penicillium as well as any others. In one aspect, the systems and methods can be used to inhibit molds, in part by inhibition of oxygen availability to the molds. The inhibition of oxygen availability can inhibit the fungi, and likely inhibit other microbes that utilize oxygen (e.g., aerobic microbes).

A container having a food can function as a preservation system by having the silverized biomass also present in the container, but the silverized biomass is separate from the food or in any location in the container so as to not be touching the food. The presence of the silverized biomass in the container without contacting the food can reduce oxidation of the food and reduce microbial infection of the food. Thus, the silverized biomass can be used for inhibiting oxidation and oxygen-requiring microbe infections of the food without directly contacting the food.

Details of experiments carried out on grapes and berries are described in the Experimental Section herein. It was surprisingly and unexpectedly found that the grapes in a container with the silverized biomass were fresh and consumable after one month of storage, whereas control grapes stored in a container without the silverized biomass dried out within a week. From the experiments, it is clear that the silverized biomass of blue green algae with silver nitrate is more effective in preserving fruits than either algae or silver nitrate alone. It was also found that the silverized biomass can be used many times for preservation, such as use for preservation of a first food, and then use for preservation of second and subsequent foods. It was also found that the silverized biomass can be used for preservation of food during long storage during shipment of fruits and vegetables (e.g., across continents) without the need for cold storage.

The silverized biomass may be provided in various forms. In one example, the silverized biomass can be provide as the biomass in a silver-salt aqueous solution. In another example, the silverized biomass can be dried to remove the water to provide a dried silverized biomass. In another example, the silverized biomass can be milled into a powder. In another example, the silverized biomass can be attached to a substrate (e.g., beads, wafers, blocks, ribbons, strands, sheets, films, etc.), such as optionally with an adhesive (e.g., bioadhesive, food-grade adhesive, etc.) when the biomass does not stick to the substrate without adhesive. In another example, the silverized biomass can be loaded on and/or in a polymeric carrier, such as polymeric beads, ribbons, strands, films, sheets or other substrates, where the polymeric carrier can optionally be porous (e.g., oxygen permeable) when the silverized biomass is embedded therein. In another example, the silverized biomass can be loaded into a hydrogel (e.g., oxygen permeable). In another example, the silverized biomass can be loaded into a porous member, such as a porous substrate (e.g., polymeric substrate). In another example, the silverized biomass may be encapsulated into a semipermeable member (e.g., polydimethylsiloxane (PDMS), alumina, titania, zirconia, silanized alumina, etc.), such as an oxygen permeable membrane, whether hydrophilic or hydrophobic, that allows oxygen to pass into the encapsulant to be consumed by the silverized biomass, which retains the silverized biomass therein. In another example, the silverized biomass can be embedded in an oxygen porous membrane, matrix, or film. In another example, the silverized biomass in a nanoparticle form may be used as described in this paragraph. In another example, the silverized biomass may be compacted into a porous mass and used as described in this paragraph.

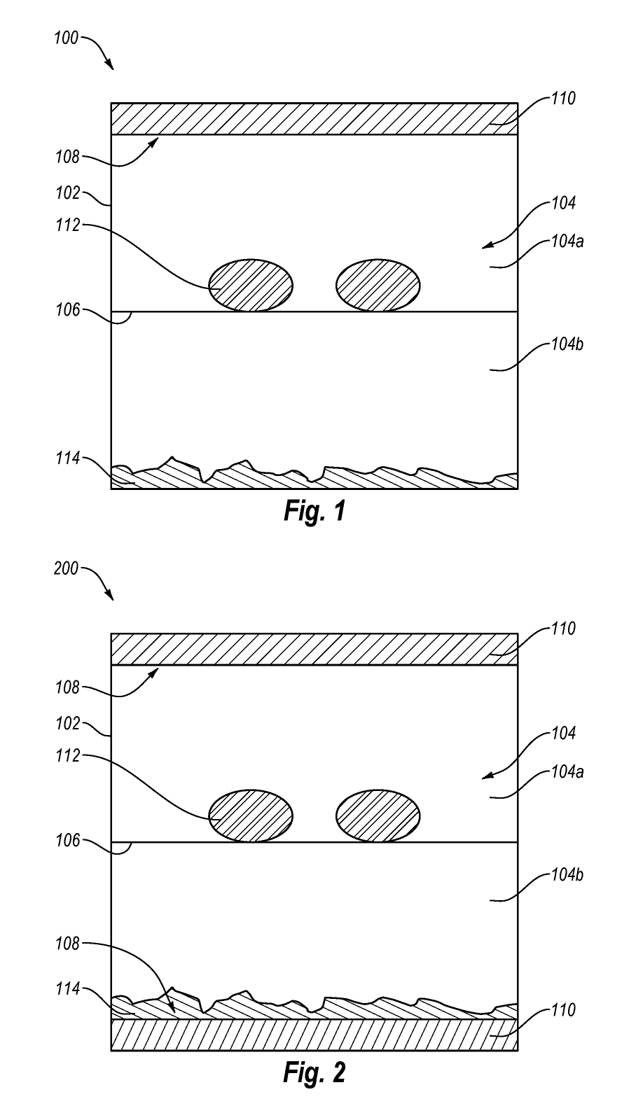

FIG. 1 illustrates an embodiment of a food preservation system 100. The food preservation system 100 can include a container 102 that has an internal chamber 104 separated by a support member 106 into a first chamber 104a and a second chamber 104b. The first chamber 104a is shown to be over the second chamber 104b, however these chambers can be side-by-side or the first chamber 104a can be under the second chamber 104b. The container 102 can have an opening 108 that can be closed and sealed with a lid 110. The lid 110 can form an airtight coupling with the container 102. The lid 110 can be fit onto the container 102 in any way, such as threading, snap fit, friction fit, or the like. While not shown, a sealing member (e.g., O-ring, gasket, etc.) may be used to enhance the sealing of the lid 110 to the container 102 to form an airtight system in the chamber 104. The first chamber 104a can be configured to receive food, and the second chamber 104b can be configured to receive silverized biomass, or vice versa. In one aspect, the support member 106 may be fixed or integrated with the container 102, adjustable in the chamber 104 (e.g., adjustable height), or removable therefrom. As shown, food 112 is placed on the support member 106 in the first chamber 104a, and silverized biomass 114 is in the bottom of the second chamber 104b. However, the silverized biomass may be coated on the side walls of any portion of inner surface of the second chamber 104b.

In one embodiment, the lid 110 may be a seal that seals the opening 108 and that can be unsealed to open the opening 108. As such, the lid 110 may be part of the container 102 that can open and close. An example of such a lid 110 can include a tongue in groove system that can be opened or closed.

FIG. 2 illustrates another embodiment of a food preservation system 200 that includes the features of the system of FIG. 1. However, instead of being a container with a fixed bottom, the container 102 has two openings 108 and two lids 110. This allows for the second chamber 104b to be opened for loading additional silverized biomass 114 or exchanging used silverized biomass 114 for new silverized biomass 114. Also, when the silverized biomass 114 is loaded into or onto a carrier, the carrier can be exchanged.

In one example, the silverized biomass can be loaded on or adhered to the lid 110 for the opening 108 of the second chamber 104b. This can allow manufacturing the lids 110 to have the silverized biomass 114, and the lids 110 can be moved between different containers 102.

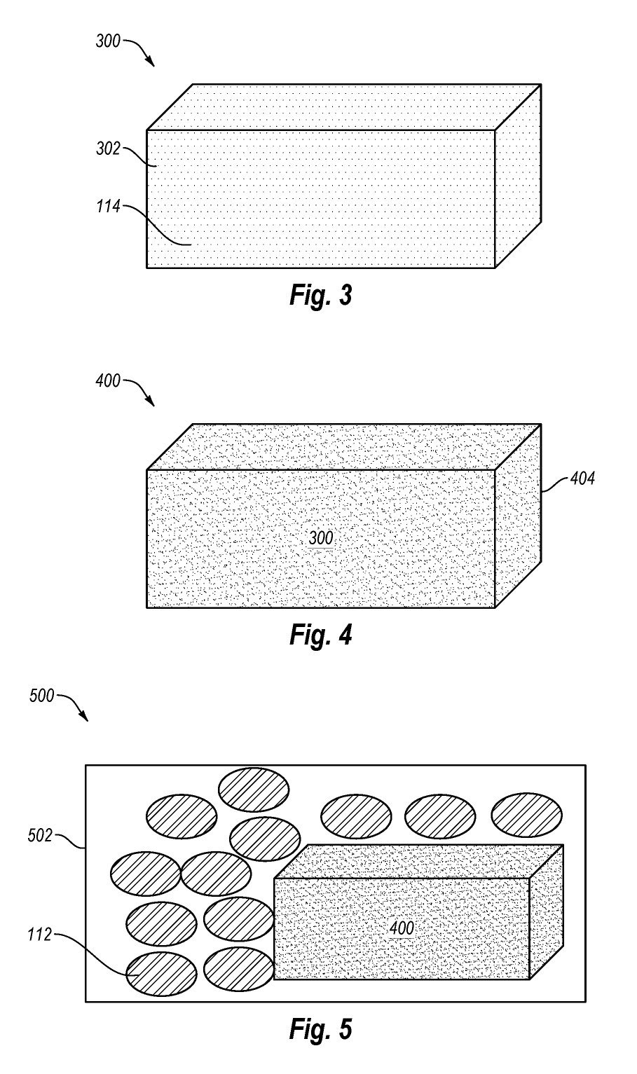

FIG. 3 illustrates an embodiment of food preservation package 300 that has a carrier 302 (e.g., represented by the blank bulk) containing the silverized biomass 114 (e.g., represented by the pattern fill dots). The silverized biomass 114 may be suspended in the carrier 302, such as homogeneously distributed or in a gradient (e.g., higher concentration at perimeter or higher concentration in center or middle). The carrier 302 can be porous or oxygen permeable. In one example, the carrier 302 includes a polymeric matrix that is oxygen permeable. The package 300 may be used in the food preservation system 100 of FIG. 1 or food preservation system 200 of FIG. 2 as the silverized biomass. That is, the package 300 can be included in the second chamber 104b where the silverized biomass 114 is shown.

FIG. 4 illustrates another embodiment of a food preservation package 400 that has a porous container 404 that contains the package 300. That is, the package 300 is loaded into a porous container 404 so that the package 300 only contacts the porous container 404. This allows the porous container 404 to be placed in a food container without the silverized biomass 114 contacting the food in the food container. The pores of the porous container 404 may be smaller than the dimension of the package 300 so that the package 300 does not pass through the pores. This can retain the package 300 in the porous container 404 as shown. The porous container 404 may have one or more walls that are oxygen permeable. Whole the porous container 404 is shown to have the package 300, the porous container 404 may have the silverized biomass 114 without a carrier when the pores are sufficiently small to retain the silverized biomass 114 therein.

FIG. 5 illustrates an embodiment of a food preservation system 500 employing the food preservation package 400 of FIG. 4. As shown, a container 502 (e.g., rigid or flexible) can include the food preservation package 400 with food 112. Because the food preservation package 400 includes the silverized biomass 114 therein, the package 400 may contact the food 112 without the silverized biomass 114 contacting the food. In one option, the package 400 can be devoid of the carrier 302 when the pores of the porous container 404 are larger than the silverized biomass 114. It should be recognized in some instances the container 502 may include the package 300 instead of the illustrated package 400.

Accordingly, a food preservation system can include a porous package (e.g., an oxygen permeable package) having at least one gas (e.g., oxygen) permeable member defining a package chamber therein, and include a silverized biomass in the package chamber of the porous package. The silverized biomass can have a combination of silver and biomass as described herein. The food preservation system can include a carrier having the silverized biomass located thereon and located in the package chamber. The carrier can be any type of carrier, whether rigid or flexible and deformable. The gas permeable member may be a substrate that has the silverized biomass thereon. The gas permeable member as a substrate can include the silverized biomass coated thereon, and configured into a gas permeable package so that the package walls of the package chamber have the silverized biomass. A gas (e.g., oxygen) permeable carrier can have the silverized biomass contained therein, where the carrier can encapsulate the silverized biomass or otherwise act as a carrier to contain and retain the silverized biomass. In one example, the gas permeable carrier includes a polymer. While the technology is described to include porous members that are oxygen permeable, the porous members may be permeable to any desired gas. The porous members may be defined as not being airtight so that gas can pass therethrough.

In one embodiment, the porous (e.g., oxygen permeable) package includes a container with an opening and a lid removably attachable to the container to cover the opening. As such, the porous package can have a sealable opening. This can allow for the package to be opened and/or closed and sealed. Alternatively, the porous package can be devoid of an opening, such as a sealed plastic bag. For example, any common food package, whether rigid or flexible that can be opened and closed or that is not re-sealable can be modified to include the silverized biomass.

In one embodiment, a food preservation system can include a container having an internal chamber. A gas (e.g., oxygen) permeable divider can located in the internal chamber and can divide the internal chamber into a first chamber and a second chamber. The first chamber can be configured for receiving food therein. A silverized biomass can be located in the second chamber. A carrier having the silverized biomass can be located thereon or contained therein and located in the second chamber. In one aspect, the container has at least one opening. The container can include at least one lid removably attachable to the container to cover the at least one opening. Each lid and the container can have: cooperative threading; friction couplings, snap-fit couplings; or fasteners that fasten the lid and container together. In one aspect, the second chamber can be devoid of an opening, such that the second chamber may not be openable and re-closable. In one aspect, the container is devoid of an opening, and the container is sealed with the silverized biomass contained in the second chamber, such as a sealed plastic bag.

A method of preserving food can include retaining a food in a container that includes silverized biomass such that the food does not contact the silverized biomass. This allows the silverized biomass to consume the oxygen in the container so as to inhibit oxidation of the food and inhibit microbial contamination of the food.

The food preservation system can include an oxygen permeable package having at least one oxygen permeable member defining a package chamber therein. That is, the package may have one wall that is oxygen permeable. When the silverized biomass is in the package chamber, the oxygen permeable member (e.g., wall) can allow oxygen into the package chamber so as to be consumed by the silverized biomass. The oxygen permeable member can be rigid such that the oxygen permeable package has a defined shape. Containers that are rigid (e.g., jars) are well known. Alternatively, the oxygen permeable member is flexible such that the oxygen permeable package is deformable. Containers that are flexible (e.g., bags) or polymer packages are well known. Both types of food containers can be adapted and modified as described herein to have an oxygen permeable member that defines the package chamber having the silverized biomass.

In one embodiment, a carrier can have the silverized biomass located thereon and the carrier can be located in the package chamber. The carrier can be any type of material that can carry the silverized biomass. In one example, the carrier is a substrate that has the silverized biomass attached thereto. The silverized biomass may adhere to the substrate with or without an adhesive. In one aspect, the substrate is rigid so as to have a defined shape. In another aspect, the substrate is flexible so as to be deformable. The substrate may be porous and/or oxygen permeable, or it may not be porous or oxygen permeable. When a porous substrate, the substrate has pores of a dimension smaller than the silverized biomass or particles of the silverized biomass so that the silverized biomass does not pass through the substrate. The substrate can be in a form of at least one bead, wafer, block, strand, ribbon, sheet, film, or combinations thereof. The substrate can be polymeric, metal, ceramic, composite, or combination thereof, or any suitable material. Optionally, the substrate may be antimicrobial. The substrate may be hydrophilic, or the substrate may be hydrophobic.

In one embodiment, the at least one oxygen permeable member defining a package chamber therein is a substrate has the silverized biomass thereon, such as coated (e.g., with carrier) or otherwise adhered thereto. An adhesive can be used for adhering the silverized biomass or carrier having the silverized biomass to the oxygen permeable substrate. In one aspect, the oxygen permeable substrate is rigid so as to have a defined shape. In another aspect, the oxygen permeable substrate is flexible so as to be deformable. The oxygen permeable substrate may include pores of a dimension smaller than the silverized biomass or particles of the silverized biomass to prevent the silverized biomass or particles thereof from passing through the oxygen permeable substrate, which retains the silverized biomass within the package chamber. The oxygen permeable substrate can be polymeric, metal, ceramic, composite, or combination thereof. Optionally, the oxygen permeable substrate is antimicrobial. The oxygen permeable substrate can be hydrophilic, or the oxygen permeable substrate can be hydrophobic.

In one embodiment, food preservation system can include an oxygen permeable carrier having the silverized biomass contained therein. Such an oxygen permeable carrier can be located in the package chamber. The oxygen permeable carrier can include a polymer, or other suitable material. The oxygen permeable carrier can be rigid so as to have a defined shape. The oxygen permeable carrier can be flexible so as to be deformable. In one example, the oxygen permeable carrier is a hydrogel. The oxygen permeable carrier can have pores of a dimension smaller than the biomass or particles of the biomass. The oxygen permeable carrier can be configured into a form of at least one bead, wafer, block, strand, ribbon, sheet, film, or combinations thereof. Optionally, the oxygen permeable carrier is antimicrobial. The oxygen permeable carrier can be hydrophilic, or the oxygen permeable carrier can be hydrophobic.

In one embodiment, the oxygen permeable member defining the package chamber can have pores of a dimension smaller than the silverized biomass or particles of the silverized biomass or carrier having the silverized biomass. This retains the silverized biomass in the package chamber. The porous oxygen permeable member can be oxygen permeable polymeric, porous metal, oxygen permeable ceramic, porous composite, or combination thereof. The porous oxygen permeable member can optionally be antimicrobial. The porous oxygen permeable member can be hydrophilic, or the oxygen permeable member can be hydrophobic.

In one embodiment, the oxygen permeable package can be configured as a container with an opening and a lid removably attachable to the container to cover the opening. The lid and container can have: cooperative threading; friction couplings, snap-fit couplings; or fasteners that fasten the lid and container together.

In one embodiment, the oxygen permeable package has a sealable opening that can be opened and re-closed. The sealable opening can include an elongate tongue and groove system where the elongate tongue is received into the elongate groove for sealing the opening, and the elongate tongue is removed from the elongate groove to unseal the opening. An example of such a sealable opening includes a Ziploc bag.

In one embodiment, the oxygen permeable package is deformable to seal the opening. However, the seal may not be airtight. When the package is deformable, various means can be used to seal the package, such as tying in a not or using a seal member (e.g., twist tie or clamp) to seal the opening. In one aspect, a seal member can be provided to seal the sealable opening.

The oxygen permeable package can be in the form of a bag, a box or a jar. Any packaging configuration can be used. In some instances, the oxygen permeable package is devoid of an opening. For example, the package can be sealed with the silverized biomass in the package chamber.

In one embodiment, the silverized biomass fills the package chamber. Alternatively, a void space is in the package chamber with the silverized biomass.

In one embodiment, the silverized biomass includes silver nanoparticles. Such silver nanoparticles can be formed by reduction by the biomass.

In one embodiment, a food preservation system can include a container having an internal chamber. The container can be configured as a bag, a box or a jar, or any other container. An oxygen permeable divider can be located in the internal chamber so as to divide the internal chamber into a first chamber and a second chamber. The first chamber can be configured for receiving food therein. The silverized biomass can be located in the second chamber. The container can be rigid with shape retention, or flexible and deformable. As such, one or both of the container or oxygen permeable divider can be rigid so as to have a defined shape. Alternatively, one or both of the container or oxygen permeable divider is flexible so as to be deformable. The container can include a carrier having the silverized biomass located thereon and the carrier can be located in the second chamber. In one aspect, the oxygen permeable divider is a substrate having the silverized biomass thereon. Optionally, the oxygen permeable divider is antimicrobial. The oxygen permeable divider can be hydrophilic, or the oxygen permeable divider can be hydrophobic. In one aspect, the oxygen permeable divider has pores of a dimension smaller than the biomass or particles of the biomass. The oxygen permeable divider can be an oxygen permeable polymer, porous metal, oxygen permeable ceramic, porous composite, a net, mesh, or combination thereof.

The container can have at least one opening. Accordingly, at least one lid can be removably attachable to the container to cover the at least one opening. Each lid and the container have: cooperative threading; friction couplings, snap-fit couplings; or fasteners that fasten the lid and container together. The container can have one opening from the first chamber. Alternatively, the container can have one opening from the first chamber and one opening from the second chamber. In another alternative, the second chamber is devoid of an opening. When present, the at least one opening can be a sealable opening. In one example, the sealable opening includes an elongate tongue and groove system where the elongate tongue is received into the elongate groove for sealing the opening, and the elongate tongue is removed from the elongate groove to unseal the opening. In another example, the container is deformable to seal the sealable opening, such as by tying the container in a knot or twist-tying the container. Also, a seal member can be used to seal the sealable opening. In one aspect, the container is devoid of an opening, and thereby the container can be punctured or caused to have an opening in order to access the food therein.

In one embodiment, the container is sealed with the silverized biomass contained in the second chamber. The silverized biomass can fill the second chamber so that there is no void space or head space. Alternatively, a void space head space can be included in the package chamber with the silverized biomass.

In one embodiment, a method of preserving food can be performed with any of the food preservation systems or package components thereof. Such a method of food preservation can include retaining a food in a container that includes silverized biomass such that the food does not contact the silverized biomass. The food and silverized biomass may be in separate chambers of the container. Alternatively, the silverized biomass can be included in an oxygen permeable package or carrier that is included in the chamber with the food in the container. In one example, the method includes retaining the food on one side of an oxygen permeable divider and retaining the silverized biomass on the other side of the oxygen permeable divider. In another example, the silverized biomass is contained in an oxygen permeable package in the container with the food. The silverized biomass can be located on or in a carrier, where the carrier is in the container with the food. The silverized biomass can be included in an amount sufficient to consume enough oxygen in the container so as to inhibit oxidation of the food. The silver biomass can be included in an amount sufficient to consume enough oxygen in the container to inhibit microbial contamination of the food. In one option, the food is placed on the oxygen permeable divider so as to be separated from the silverized biomass that is on the other side of the oxygen permeable divider. In one aspect, the food and oxygen permeable divider are located above the silverized biomass. In one aspect, the container is airtight, and the silverized biomass is retained for a sufficient duration to remove oxygen from the chamber having the food. The container can be a sealed package without an opening.

In some instances, the oxygen-consuming potential of the silverized biomass may be depleted. As such, the method of preserving food can include removing the silverized biomass from the container, and introducing a second silverized biomass into the container.

The method of preserving food can include cooling the container having the food and silverized biomass. The cooling can be to below or about 30° C., below or about 25° C., below or about 20° C., below or about 10° C., below or about or about 4° C., or below freezing (e.g., 0° C.). Such cooling can be in a refrigerator or freezer. Alternatively, the method can include storing the container having the food and silverized biomass at ambient conditions. The ambient conditions can be outside temperature or room temperature in a building. The ambient conditions can be without any cooling or heating. When in cold climates, the container having the food and silverized biomass may be heated, such as to room temperature (e.g., about 25° C.).

While some embodiments may have a container that is airtight, alternative embodiments can include a container that leaks oxygen so as to be not completely airtight. The exchange of air and entrance of oxygen into the chamber should be sufficiently low so that the food preservation can be achieved.

The method of food preservation can be conducted for short or long durations. This can include durations during shipping of the container having the food and silverized biomass from a first location to a second location, which may be close to each other (e.g., less than 10 miles) or far apart (e.g., thousands of miles). For example, the method can include storing the container having the food and silverized biomass for at least one month.

In one embodiment, the silverized biomass is included in an aqueous solution having silver ions. Alternatively, the silverized biomass is dried. In another option, the silverized biomass is included in a carrier, such as a hydrogel or porous encapsulating material. In one aspect, the silverized biomass includes silver nanoparticles.

The silverized biomass may be used repeatedly with different foods. That is, once one food is removed from the preservation system, another food can be introduced with the same silverized biomass. As such, the method can include removing the food from the container, introducing a second food into the container with the same silverized biomass. The method can also include sealing the container with the second food therein.

In one embodiment, the method can be performed with air in the container. Alternatively, the method can include evacuating gas from the container having the food and silverized biomass. The method can include evacuating oxygen from the container having the food and silverized biomass. In one aspect, the method can include introducing an antimicrobial gas into the container having the food and silverized biomass.

The food that can be preserved in the food preservation can be any type of food, whether plant-based or animal-based. In one aspect, the food is a cultivated food. In one aspect, the food is a prepared food that may or may not be cooked; however, the food has undergone some processing from its native or harvested condition. In one aspect, the food is a cooked food.

### EXPERIMENTAL

Cyanobacteria (e.g., Leptolyngbya valderiana) was processed with silver to form silverized biomass particles. The silverized biomass particles were introduced into a chamber at the bottom, with a net suspended over and not contacting the biomass, where grapes and berries were placed on the net. The container was left at ambient conditions during the summer and monsoon season such that the temperature varied between 25° C. to 42° C., while the humidity varied from 66% to 88% over a few weeks.

Healthy growing biomass of L. valderiana (10 mg or 200 mg) was exposed to 100 ml of 9 mM silver nitrate (AgNO₃) solution (pH 3.86), and kept in dark condition at room temperature. After 72 hours the whole biomass had turned brown in color, and was determined to be dead.

Silver nitrate (0.15 g) can be used for production of 200 mg dead silver loaded biomass (e.g., 200 mg biomass exposed in 100 ml of 9 mM silver nitrate solution). However, the amounts of silver or biomass can range.

Berries (Syzygium cumini) were placed in four containers and hung on nets. In a first container, no silver or biomass was used as a control (e.g., A1). In a second container, only silver nitrate was added (e.g., A2). In a third container, only biomass was added (e.g., A3). In a fourth container, silver nitrate and algae (e.g., silverized biomass) was added (e.g., A4). In no instance did the berries contact any silver or biomass or silverized biomass. The containers were kept sealed (e.g., airtight) in dark condition at 25° C. After 5 days, it was observed that the berries remained fresh and edible in the sample A4 with the silverized biomass. However, in the control, silver only, or biomass only containers (e.g., A1, A2, and A3) the berries either dried up or had become infected with fungus. Accordingly, only the silverized biomass preserved the berries, and the others were not considered to be edible.

Grapes were placed in a container hung on a net above silverized biomass (e.g., L. valderiana at 200 mg in the silver solution at 9 mM) so that the grapes were only in contact with the net. The container was sealed so that the grapes did not contact the silverized biomass, and kept in dark condition at 25° C. A control container with the grapes hung on nets without any silver or biomass was also prepared. After 1 month, it was observed that the grapes remained fresh and edible in the in the container with the silverized biomass, but in the control container the grapes had dried up and were not edible.

In one aspect, it is estimated that silverized biomass may be used for up to 500 or up to 1000 preservation procedures. As such, once preserved food is removed from a container having the silverized biomass, more food can be introduced into the container and sealed for preservation. Experimentally, the same silverized biomass has been used six times for treating berries, and the results were the same and indicate that the silverized biomass can be used repeatedly. It is determined that if the silverized biomass can be used repeatedly and can be used for a month, then it can be used for longer term storage and preservation, such as 2 months, 3 months, up to 6 months, and possibly longer.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A food preservation system, comprising:
a porous package having at least one gas permeable member defining a package chamber therein; and
a silverized biomass in the package chamber of the porous package, the silverized biomass having a combination of silver and a biomass.

2. The food preservation system of claim 1, comprising a carrier having the silverized biomass located thereon or therein and the carrier is located in the package chamber.

3. The food preservation system of claim 2, wherein the carrier is a gas permeable carrier that includes a polymer material with desired gas permeability.

4. The food preservation system of claim 1, wherein the porous package has a container with an opening and a lid removably attachable to the container to cover the opening.

5. The food preservation system of claim 1, wherein the porous package is devoid of an opening.

6. The food preservation system of claim 1, wherein the biomass includes algae and the silver is a silver salt.

7. A food preservation system comprising:
a container having an internal chamber;
a gas permeable divider located in the internal chamber so as to divide the internal chamber into a first chamber and a second chamber, the first chamber is configured for receiving food therein; and
a silverized biomass in the second chamber, the silverized biomass having a combination of silver and a biomass.

8. The food preservation system of claim 7, comprising a carrier having the silverized biomass located thereon or contained therein and the carrier is located in the second chamber.

9. The food preservation system of claim 7, comprising at least one lid removably attachable to the container to cover the at least one opening.

10. A method of preserving food, comprising:
retaining a food in a container that includes a silverized biomass such that the food does not contact the silverized biomass, the silverized biomass having a combination of silver and a biomass.

11. The food preservation system of claim 1, wherein the gas permeable member is a substrate having the silverized biomass thereon.

12. The food preservation system of claim 1, comprising a gas permeable carrier having the silverized biomass contained therein, the gas permeable carrier is located in the package chamber.

13. The food preservation system of claim 1, wherein the porous package has a sealable opening.

14. The food preservation system of claim 7, wherein the container has at least one opening.

15. The food preservation system of claim 7, wherein second chamber is devoid of an opening.

16. The food preservation system of claim 7, wherein the container is devoid of an opening, and the container is sealed with the silverized biomass contained in the second chamber.

17. The food preservation system of claim 7, wherein the biomass includes algae.

18. The food preservation system of claim 7, wherein the silver is a silver salt.

19. The food preservation system of claim 9, wherein each lid and the container have: cooperative threading; friction couplings, snap-fit couplings; or fasteners that fasten the lid and container together.

20. The food preservation system of claim 10, wherein the biomass includes algae and the silver is a silver salt.
